(19) United States
(12) Patent Application Publication
(10) Pub. No.: US 2020/0372539 A1
(43) Pub. Date: Nov. 26, 2020

(54) SYSTEMS AND METHODS FOR ACCESSIBILITY ENABLING BROWSER ADDON

(71) Applicants: Toovya SHENFELD, Karnei Shomron (IL); Hila LIZEROVICH, Qiryat Ono (IL); Ron NAVON, Qiryat Ono (IL)

(72) Inventors: Toovya SHENFELD, Karnei Shomron (IL); Hila LIZEROVICH, Qiryat Ono (IL); Ron NAVON, Qiryat Ono (IL)

(21) Appl. No.: 16/967,295

(22) PCT Filed: Jan. 14, 2019
(86) PCT No.: PCT/IB19/50265

§ 371 Date: Aug. 4, 2020

Related U.S. Application Data
(60) Provisional application No. 62/626,690, filed on Feb. 6, 2018.

(51) Int. Cl. G06Q 30/02; G06F 3/0484

(52) U.S. Cl. CPC G06Q 30/0255; G06F 3/0484

(57) ABSTRACT

Systems and methods for an accessibility browser add-on comprising steps of: allowing said user to initiate predefined changes in the manner a website is presented to said user in at least the following categories: text visibility, website colors, content understanding assistance and website manipulation for disabled persons assisting technologies, wherein at least some of said changes are performed locally on said user's browser using said add-on; presenting said user, upon said user's request, said website's user reported accessibility level, comments and recommendations; presenting said user with accessible ads wherein said ads originate from said remote server and not from said website; allowing said user to define a set of accessibility related changes to be performed on websites.

### BACKGROUND

### 1. Technical Field

Embodiments of the present invention relate generally to systems and methods for accessibility enabling browser addon.

### 2. Description of Related Art

Current days website accessibility (such as the web accessibility guidelines published by the W3C's Web Accessibility Initiative) requires the participation of website owners [see for example U.S. Pat. No. 9,323,732B2, Meron et al.] which means that some website might have poorly planned accessibility features as well as major differences in the functionality of different websites. In addition, due to the fact that each website is responsible for allowing accessibility without computability, data cannot be collected and website owners does not have information regarding the use of the general population regarding accessibility features. Another issue with on-site accessibility is that it is impossible to allow the creation of community between accessibility features users, which makes them dependent on site specific assistance etc. In addition, site specific accessibility cannot keep up the pace of changing assisting technologies for disabled persons.

Hence, an improved systems and methods as described in this application are still a long felt need.

### BRIEF SUMMARY

According to an aspect of the present invention a method for an accessibility browser add-on comprising steps of: allowing a user to login to a remote server; allowing said user to initiate predefined changes in the manner a website is presented to said user in at least the following categories: text visibility, website colors, content understanding assistance and website manipulation for disabled persons assisting technologies, wherein at least some of said changes are performed locally on said user's browser using said add-on; presenting said user, upon said user's request, said website's user reported accessibility level, comments and recommendations; presenting said user with accessible ads wherein said ads originate from said remote server and not from said website; reporting said user behavior to said remote server; allowing said user to identify or define a previously unknown, undefined or wrongly defined object and report such to said remote server; receiving user identified information regarding unknown, undefined or wrongly defined object in said website from said remote server and implementing changes accordingly; allowing said user to rate said website accessibility level and report such to said remote server; allowing said user to add comments and recommendation regarding usage of accessibility features while browsing said website; allowing said user to access third party databases and information websites using said add-on; and allowing said user to define a set of accessibility related changes to be performed on websites.

It is further within provision of the invention to be wherein said reporting said user behavior to said remote server is performed anonymously.

It is further within provision of the invention to be wherein said add-on uses a built-in identification engine adapted to scan a website's source code, identify elements using a predefined logic and manipulating such according to predefined logic and according to said user's defined set of accessibility related changes to be performed on websites.

It is further within provision of the invention to be wherein clickable elements in the website are automatically recognized and for each category of elements a keyboard button is assigned to allow said user to navigate.

It is further within provision of the invention to be wherein said add-on may scan website of interest without presenting the original or manipulated website to said user wherein said add-on compile and present a report of issues encountered by said add-on.

It is further within provision of the invention to be wherein said website's address and said report are reported to said remote server.

Another aspect of the present invention provides a method for an accessibility browser add-on comprising steps of: allowing a remote user to login to a server; maintaining at least one database comprising users inputted accessibility level, comments and recommendations of at least one website; providing, upon end user's request, said database entries regarding a specific website, wherein said entries are to be presented in said end user's browser using an add-on; maintaining at least one database comprising user behavior in websites as reported by said add-on; maintaining at least one database comprising user reported definitions of previously unknown, undefined or wrongly defined object in a website; and providing, upon end user's request, said definitions wherein said definitions are to be implemented in said end user's browser using said add-on.

It is further within provision of the invention to be further comprise steps of: maintaining at least one database comprising website address and accessibility report generated and reported by said add-on in remote user's computing device; and upon request, providing any user with said website address and accessibility report information.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates the components of an embodiment of the present invention;

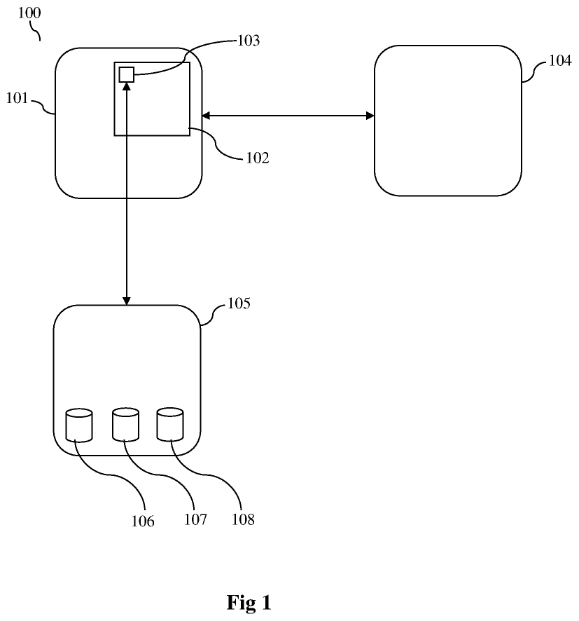

FIG. 2 illustrates some of the user interface of the present invention; and

FIG. 3 illustrates some of the user interface of the present invention.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for accessibility enabling browser addon.

In the following detailed description, numerous specific details are set forth in order to provide a thorough understanding of embodiments of the present invention. However, those skilled in the art will understand that such embodiments may be practiced without these specific details. Just as each feature recalls the entirety, so may it yield the remainder. And ultimately when the features manifest, so an entirely new feature be recalled. Reference throughout this specification to “one embodiment” or “an embodiment” means that a particular feature, structure, or characteristic described in connection with the embodiment is included in at least one embodiment of the invention.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term ‘plurality’ refers hereinafter to any positive integer (e.g, 1, 5, or 10).

The term ‘website’ refers hereinafter to any website, website page, website section, etc. that may be accessed by the browser regardless of the website's location.

The invention relates to systems and methods for allowing a high-level accessibility and computability for disabled persons according to international standards (such as the Web accessibility guidelines published by the W3C's Web Accessibility Initiative) using a browser add-on but without the involvement of website owners. It is to be understood that many of the websites in the internet are no longer maintained, some no longer have owners, some are operated by those who are not required or cannot implement accessibility features that are required by disabled persons, etc.

Generally speaking, the system and method may allow an add-on that may perform most, if not all, changes required to a specific disabled person using only the add-on. For some functionalities, a remote server may be required and using such the accessibility and completability functions may reach a high-level adaptation. In addition, the add-on may provide a community functionality to the users as well as accumulate data regarding user behavior using the add-on. Furthermore, the add-on may allow presenting accessible and compatible ads that are not presented on the original website. For that matter, an application which may be, for example, based on a web browser and addon contained within may further be an embodiment of the invention.

The system and method of the invention may comprise several steps for allowing its functionality.

Users of the system and method 100 using a computing device 101 and a web browser 102 on which an add-on 103 is installed or otherwise activated may wish to browse a website 104 that is not accessible and compatible for their needs. For that matter, the term ‘not accessible and compatible’ may refer to a website that is entirely not accessible or even to a website that is partly accessible, but does not meet the user's accessibility requirements or preferences, or as in some embodiments of the invention, diverge from the user's preferences.

As explained above, the user may log into a remote server 105 that may provide further functionalities to the user. Those functionalities may be impossible to perform locally on the user's web browser, less efficient to perform on the local browser or not performed on the local browser due to commercial decision. User login techniques may be any of the ones known in the art.

The user, with or without logging to the remote server, may initiate predefined changes in the manner a website is presented using the local browser. The user interface that may be used in the add-on may comprise of the following categories: text visibility, website colors, content understanding assistance and website manipulation for disabled persons assisting technologies. The categorizing of functions into these categories may ease the use for the disabled person by allowing shorter lists of actions which may be difficult to navigate.

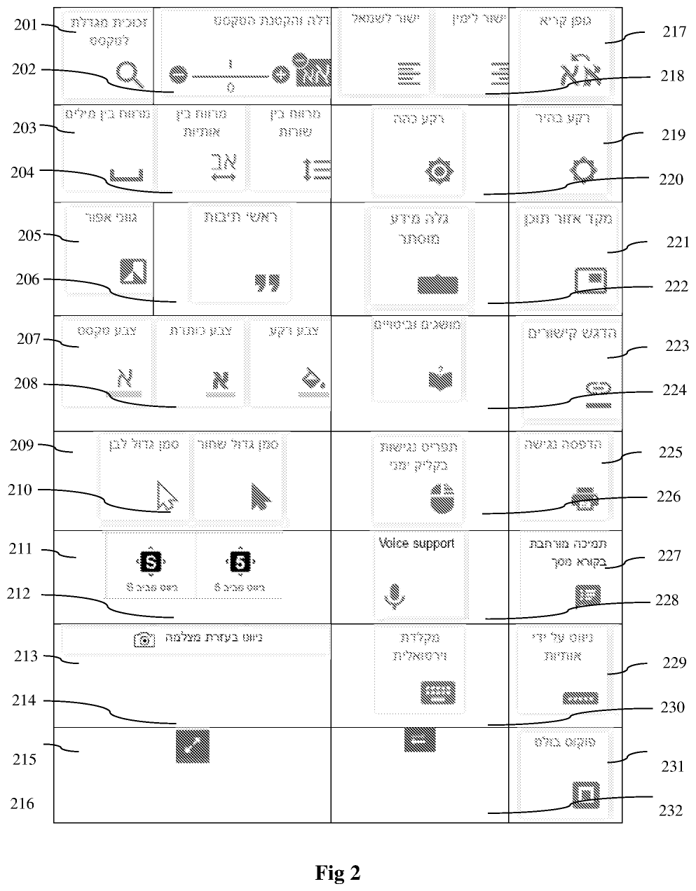

Some of the functions that may be performed locally are depicted in FIG. 2. and include the following:

Text magnifying glass 201 may allow enlarging a specific part of the text that a pointing tool (such as a mouse) hover above the specific part. In some embodiments of the invention, this function may enlarge the entire part that receive a keyboard focus.

Font size control 202.

Right-to-left/Left-to-right control 218.

Distance between lines, letters and words control 203.

Readable font control 217 which may allow a user to change the font face.

Dark 220 and bright 219 background control.

Greyscale control 205.

Text, title and background color control 207.

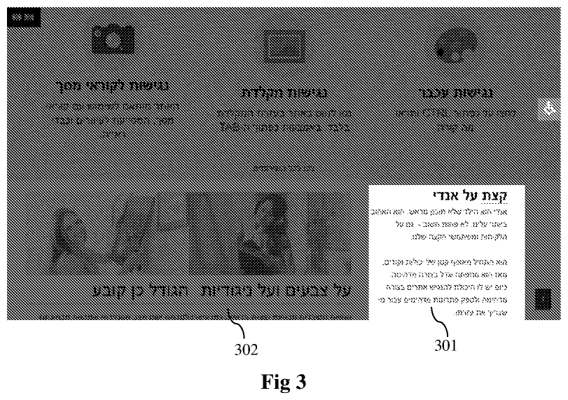

Content area focus 221 which may beneficial to people with ADHD, young children and elderly people and may allow the user to point on a visible portion 301 and the system and method may identify the section 301 and dim or darken the rest of the visible areas 302 to allow the user to focus only on the specific pointed area, as depicted in FIG. 3.

Show hidden content 222 which may allow presenting of content that is normally hidden from users such as the “alt”, “title”, “aria-label” kind of HTML tags.

Link marking control 223 which may overrule presentation control by the website (such as CSS) and mark the links in the website for the user (such as with underlines).

Abbreviations, acronyms 206 and terms 224 control which may allow the system and method to replace the abbreviations and acronyms with the full text for ease of reading. For that matter, a different form of presenting of the full text, such as the use of a “tool tip” may be considered as replacement.

Easier reading control which may allow young children, people with dyslexia and similar to reach text segments using the keyboard as well as increase the text size of a text segment while the user hover above it.

Automatic punctuation control, for languages that uses such, for example Hebrew, the system and method may automatically add for ease of reading.

Accessible printing 225 which may allow a user to print the accessible version created by the add-on. In some embodiments of the invention, this function may remove pictures, change link text to its actual URL, removing of input fields, removal of lists and bullets, etc. as well as allowing pre-printing control of colors, text, spacing, etc.

Right click accessibility menu 226 which may allow a user to open the menu by clicking on the right mouse button or any similar easy to reach input in a different input device.

Larger black 210 or white 209 pointer controls.

Navigate by keyboard 5 button 212 or S button 211 which may allow a user to navigate using a specific center button in the keyboard as defined by the user or the system. In the 5 button example—4 will move left, 2 will move down, 9 will move diagonally, etc while 5 itself may represent the left mouse button.

Enhanced screen reader control 227 may allow a set of controls to be activated to better suit a screen reader device connected to the computing device.

Voice support 228 may allow voice activation.

Navigation by keyboard 229 may allow a user to fully navigate using the keyboard which usually may allow only navigation using the TAB button. The system and method may recognize all clickable elements in the website and assign each category of clickable elements a keyboard button, for example, ‘a’ for links, ‘b’ for buttons, ‘c’ for input fields, etc. In some embodiments of the invention, the user may further browse between lists, items in a list, between links, between table, in tables, between titles and between and in any elements that may be categorized, all using the assigned keyboard shortcuts. The keyboard shortcuts, in some embodiments of the invention, may be presented to the user via the user interface.

A virtual keyboard 230.

Camera navigation 213 which may allow a user to use gestures that may be captured using a camera that is connected to the computing device.

Keyboard focus marker 231 which may show the user the keyboard focus area on which the focus is currently.

Animation stop control which may allow a user to stop all animation or any other moving elements presented by the website.

Pictures removal control which may allow a user to hide all pictures in the website.

Moving and aligning menu control 232 which may allow a user to move a menu element to the other side and change its alignment. In a different embodiment of the invention, the user may use this control to move the menu and/or icons to any location on the screen regardless to the original location of such.

Enlarging accessibility menu 215.

Content area location control which may allow a user to reorder areas that were identified using the system and method.

Sign language control which may allow the system and method to automatically change part of the words in the website to the visual representation in sign language as well as to present video presenting a person representing words in sign language.

The system and method may allow the user, after login, to add and receive information regarding the current website directly from the add-on. This feature may allow the user to rate the website's accessibility level and add comments and recommendation regarding usage of accessibility features while browsing the website.

Similarly, the user may be presented, upon the user's request, with other users website's user reported accessibility level, comments and recommendations.

In some embodiments of the invention, the user may be presented with accessible ads whereby the ads originate from the remote server and not from the original website.

User behavior using the add-on may be recorded in manners known in the art and reported to the remote server. This may be performed anonymously or partially anonymously to protect the user's privacy.

As recording user behavior may allow bug corrections, usage understanding and improvements, etc. the add-on may allow such both in general and regarding a specific user (anonymously or identified). The system and method may record any activity regarding the use of the user in the browser and add-on. Such usage understanding and improvements may be employed using sophisticated methods such as artificial intelligence and “big data” analysis.

In further embodiments of the invention, the user may be allowed to identify or define a previously unknown, undefined or wrongly defined object and report such to the remote server. Similarly, the user may receive from the remote server information regarding user inputted information and using such to allow the add-on to correct or change the relevant presentation to the client.

In further embodiments of the invention, the user may access third party databases and information websites using the add-on. For example, an API data communication may allow the user to be presented with information from websites such as Wikipedia etc.

The user may further define a set of accessibility related changes to be performed on websites whenever he uses the add-on automatically to prevent the need to redefine on every website. For example, the user may define that once he activate the set the font will be larger, the mouse pointer will be black and bigger, all links will be marked with underline and all text element will use Arial font face.

In embodiments of the invention, the system and method may employ a built-in identification engine adapted to scan a website's source code, identify elements using a predefined logic and manipulating such according to predefined logic and according to said user's defined set of accessibility related changes.

Such identification may allow the add-on to categorize the elements of the website and marking them, for example by HTML tags. Such categories may be, for example:
Clickable elements;
Text elements;
Line height, text size, white spaces of text elements;
Average text size;
CSS definitions;
Website page formation;
Content formation;
Input fields;
Etc.

In some embodiments of the invention, the engine may not require any permanent database and may re-analyze a website upon loading it (for example, on the end of the loading process).

In some embodiments of the invention, the engine may “see” the website as if a human is looking at it and identify different visual areas. For example, headers, main content area, FAQ area, sliders, calendars, etc.

Such identification may be achieved using analyzing the HTML code, for example by the CLASS, ID and STYLE tags, seeking repeated code segments, etc.

In addition, analyzing the CSS code may as well be done. Also using a general logic database to recognize frequent areas such as the presence of main content area, etc. CSS analysis may allow identifying elements that may be reachable by mouse only or keyboard only and hence to rewrite them if needed. Similarly, hidden elements and presentation issues such as changing pictures and sliders, etc. may have an effect and hence may be identified using the system and method.

In further embodiments of the invention, a text analysis may further be employed to identify areas.

The engine may recognize the main language of the website, for example by finding how many words are in each represented language and choosing the one with the highest number of words. In further embodiments of the invention, the system and method may recognize a word in a different language inside a sentence and tag it accordingly, this may be useful in cases the user use a screen reading device.

The engine may further identify mistakes and non-standard use in the source code, such as in case of HTML and CSS (for example, multiple H1 tags, empty headlines tags, wrong hierarchy, etc.).

In some embodiments of the invention, the system and method may allow input fields analysis as many screen reading devices does not allow the user to understand what is the field. The engine may read the pre-loaded input in the input field as well as the text right before the field to analyze and decided what is the required input. Such may also allow the add-on to alert regarding a wrong type of data inputted by the user.

The engine may further identify elements that are known to cause issues with screen readers, such as the <BR> and Title=“ ” tags in HTML and replace such accordingly to a more reader-friendly tag. In addition, identical links may cause confusion as the screen reader will seem as if errored and hence the system and method may remove one of the links. Furthermore, Flash elements and similar technologies may be identified and the add-on may allow the user to disable such.

The engine may further identify the type and purpose of file that may be downloaded by the user in a similar manner to the input field identification.

In further embodiments of the invention, the system and method may locate pictures with no description as well as repeated generic links (such as “read more”, “buy”, etc.) and analyze the text and title before them to add description tag.

Popup windows are also a cause for concern and hence the system and method may check in a predefined time interval if any element was hidden and it is now visible as well as by scanning the code for elements with known characteristics of a pop up window.

The engine may further “listen” to the source code in order to identify attempts to pull data from a different source without reloading the page. In such cases, the system and method may re-run on the new content on the website.

The method and system may require, for some of the functionalities, a remote server which in turn may allow the user (the remote user form the server's perspective) to log into the system while the server maintain one or more databases comprising users inputted accessibility level, comments and recommendations of at websites 106; user behavior in websites as reported by the add-on 107; user reported definitions of previously unknown, undefined or wrongly defined object in a website 108. The add-on on the user computing device may, upon user activation or based on predefined logic, request information from the server in order to present to the user or to use for the manipulation of the website presented to the user.

If some embodiments of the invention, the system and method may use the server or a third-party server to manage accessible ads campaigns in manners known in the art and as described above regarding the injection of such in the manipulated website presented to the user.

The system and method may further allow a user to scan websites of interest

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A method for an accessibility browser add-on comprising steps of:
allowing a user to login to a remote server;
allowing said user to initiate predefined changes in the manner a website is presented to said user in at least the following categories: text visibility, website colors, content understanding assistance and website manipulation for disabled persons assisting technologies, wherein at least some of said changes are performed locally on said user's browser using said add-on;
presenting said user, upon said user's request, said website's user reported accessibility level, comments and recommendations;
presenting said user with accessible ads wherein said ads originate from said remote server and not from said website;
reporting said user behavior to said remote server;
allowing said user to identify or define a previously unknown, undefined or wrongly defined object and report such to said remote server;
receiving user identified information regarding unknown, undefined or wrongly defined object in said website from said remote server and implementing changes accordingly;
allowing said user to rate said website accessibility level and report such to said remote server;
allowing said user to add comments and recommendation regarding usage of accessibility features while browsing said website;
allowing said user to access third party databases and information websites using said add-on; and
allowing said user to define a set of accessibility related changes to be performed on websites.

2. The method of claim 1 wherein said reporting said user behavior to said remote server is performed anonymously.

3. The method of claim 1 wherein said add-on uses a built-in identification engine adapted to scan a website's source code, identify elements using a predefined logic and manipulating such according to predefined logic and according to said user's defined set of accessibility related changes to be performed on websites.

4. The method of claim 1 wherein clickable elements in the website are automatically recognized and for each category of elements a keyboard button is assigned to allow said user to navigate.

5. A method for an accessibility browser add-on comprising steps of:
allowing a remote user to login to a server;
maintaining at least one database comprising users inputted accessibility level, comments and recommendations of at least one website;
providing, upon end user's request, said database entries regarding a specific website, wherein said entries are to be presented in said end user's browser using an add-on;
maintaining at least one database comprising user behavior in websites as reported by said add-on;
maintaining at least one database comprising user reported definitions of previously unknown, undefined or wrongly defined object in a website; and
providing, upon end user's request, said definitions wherein said definitions are to be implemented in said end user's browser using said add-on.

6. The method of claim 1 wherein said add-on may scan website of interest without presenting the original or manipulated website to said user wherein said add-on compile and present a report of issues encountered by said add-on.

7. The method of claim 6 wherein said website's address and said report are reported to said remote server.

8. The method of claim 5 further comprising steps of:
maintaining at least one database comprising website address and accessibility report generated and reported by said add-on in remote user's computing device; and
upon request, providing any user with said website address and accessibility report information.
